(19) United States
(12) Patent Application Publication
(10) Pub. No.: US 2016/0330158 A1
(43) Pub. Date: Nov. 10, 2016

(54) Messaging Sharing System and Method of Use

(71) Applicant: Mimic Labs, Inc., Houston, TX (US)

(72) Inventor: Matt Gonzales, Houston, TX (US)

(21) Appl. No.: 15/149,065

(22) Filed: May 6, 2016

Related U.S. Application Data
(60) Provisional application No. 62/157,950, filed on May 6, 2015.

(51) Int. Cl. H04L 12/58

(52) U.S. Cl. CPC H04L 51/22

(57) ABSTRACT

An apparatus, comprising at least one memory including a computer program code. at least one processor. Wherein the at least one memory and the computer program code are configured to, with the at least one processor, cause the apparatus at least to implement a messaging application. the messaging application is in communication with a server over a network. the messaging application is installed and running on a plurality of computers. a plurality of users conduct a plurality of conversations with one another through the messaging application. each of the plurality of conversations each comprising a one or more messages between a two or more among the plurality of users. the plurality of users comprise at least a first user and a second user. the plurality of conversations comprise at least a first conversation between the first user and the second user.

### CROSS-REFERENCE TO RELATED APPLICATIONS

This application claims benefit to U.S. Patent Application No. 62/157,950 filed May 6, 2015.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to a Messaging Sharing System and Method of Use.

### BRIEF SUMMARY OF THE INVENTION

An apparatus, comprising at least one memory including a computer program code. at least one processor. Wherein the at least one memory and the computer program code are configured to, with the at least one processor, cause the apparatus at least to implement a messaging application. the messaging application is in communication with a server over a network. the messaging application is installed and running on a plurality of computers. a plurality of users conduct a plurality of conversations with one another through the messaging application. each of the plurality of conversations each comprising a one or more messages between a two or more among the plurality of users. the plurality of users comprise at least a first user and a second user. the plurality of conversations comprise at least a first conversation between the first user and the second user.

A method for creating and sharing a composite message, the method comprising: installing and running a messaging application on a plurality of computers, connecting said plurality of computers to one another and a server over a network, executing said messaging application in a memory of said plurality of computers and said server, facilitating a plurality of conversations between a plurality of users through said messaging application, creating said composite message from selection of two or more messages within a first conversation, and providing a dialog for sending said composite message to a one or more among said plurality of users. Each of the plurality of conversations comprising a one or more messages between a two or more among the plurality of users. The plurality of users comprises at least a first user and a second user. The plurality of conversations comprises at least the first conversation between the first user and the second user.

### BRIEF DESCRIPTION OF THE SEVERAL VIEWS OF THE DRAWING

FIG. 1 illustrates a first network configuration 101 of an improved messaging system 100.

FIGS. 2A, 2B, 2C and 2D illustrate a perspective overview of a mobile phone 201a, a personal computer 201b, a tablet 201c, and a smartphone 201d.

FIGS. 3A, 3B and 3C illustrate an address space 302 within said one or more computers, an address space 302a and an address space 302d.

FIGS. 4A and 4B illustrate two embodiments for collecting and storing data with said improved messaging system 100; a first embodiment with a flow diagram between said first computer 102a and said server 108, and a second embodiment comprising of just said first computer 102a.

FIGS. 5A and 5B illustrate two examples of a flow diagram between said memory 306a and said memory 306d.

FIGS. 6A, 6B and 6C illustrate a first use diagram 600, a messaging dialog app 620, and a plurality of users 650.

FIGS. 7A, 7B and 7C illustrate said first use diagram 600 with said first user 601a and said third user 601c, said first mobile device 610a and a prior art rendering of said third mobile device 610c.

FIG. 8 illustrates a hypothetical improvement to message thread forwarding within an messaging application 820.

FIGS. 9A and 9B illustrate sub-tables diagram 900 and a field relationships diagram 950.

FIG. 10 illustrates said User Table 902.

FIG. 11 illustrates said Messages Table 904.

FIG. 12 illustrates said Share Events 906.

FIG. 13 illustrates said Share Conditions 908.

FIG. 14 illustrates a share query tables 1400.

FIG. 15 illustrates a composite message data 1500.

FIGS. 16A, 16B, 16C and 16D illustrate said first user 601a, and three views of a message selection interface 1600 of said messaging application 820 on said smartphone 201d.

FIG. 17 illustrates said message selection interface 1600 in different configurations.

FIGS. 18A, 18B, 18C and 18D illustrate three figures in transition between said message selection interface 1600 and a message sharing interface 1800, and one figure of said message sharing interface 1800.

FIGS. 19A and 19B illustrate a select recipients interface 1900 and a data table view of recipient fields 1950.

FIG. 20 illustrates a select expiration interface 2000.

FIGS. 21A and 21B illustrate a portion of said plurality of users 650 and said messaging application 820 displaying said composite message box 1830.

FIG. 22 illustrates a flow chart 2200.

FIG. 23 illustrates a news feed screen 2300.

FIG. 24 illustrates a friend request screen 2400.

FIG. 25 illustrates a messenger screen 2500.

FIG. 26 illustrates a notifications screen 2600.

FIG. 27 illustrates a profile screen 2700.

FIG. 28 illustrates a flow diagram 2800.

### DETAILED DESCRIPTION OF THE INVENTION

Described herein is a messaging sharing system and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

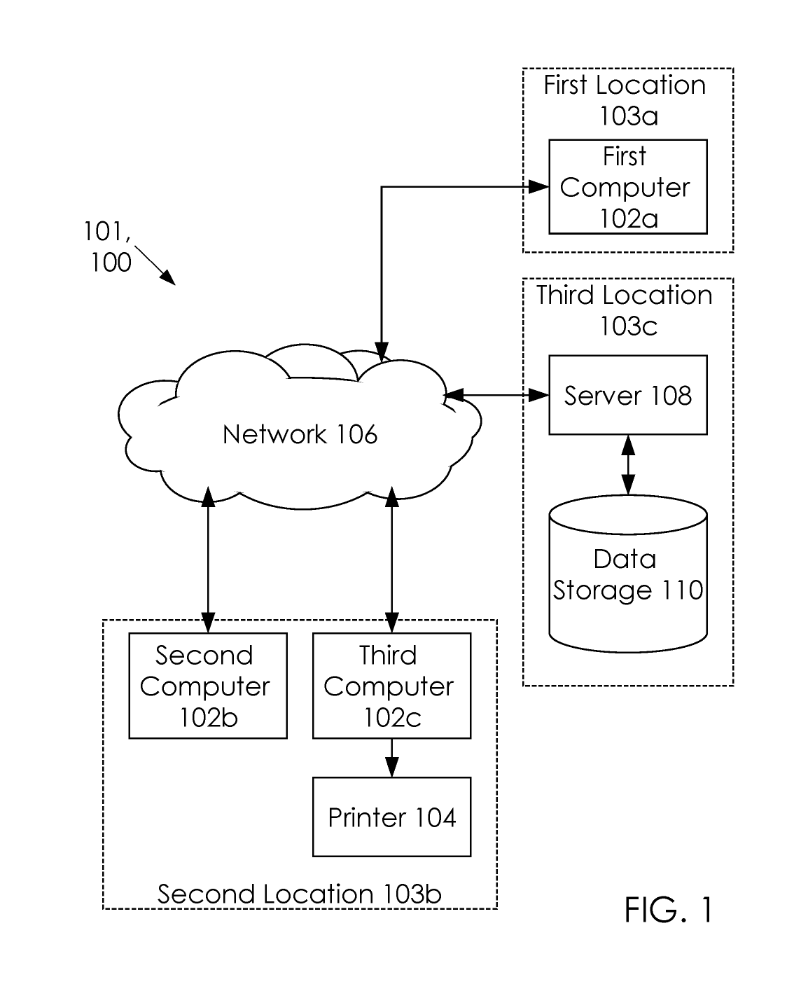

FIG. 1 illustrates a first network configuration 101 of an improved messaging system 100.

In one embodiment, said improved messaging system 100 can comprise a one or more computers at a one or more locations. In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

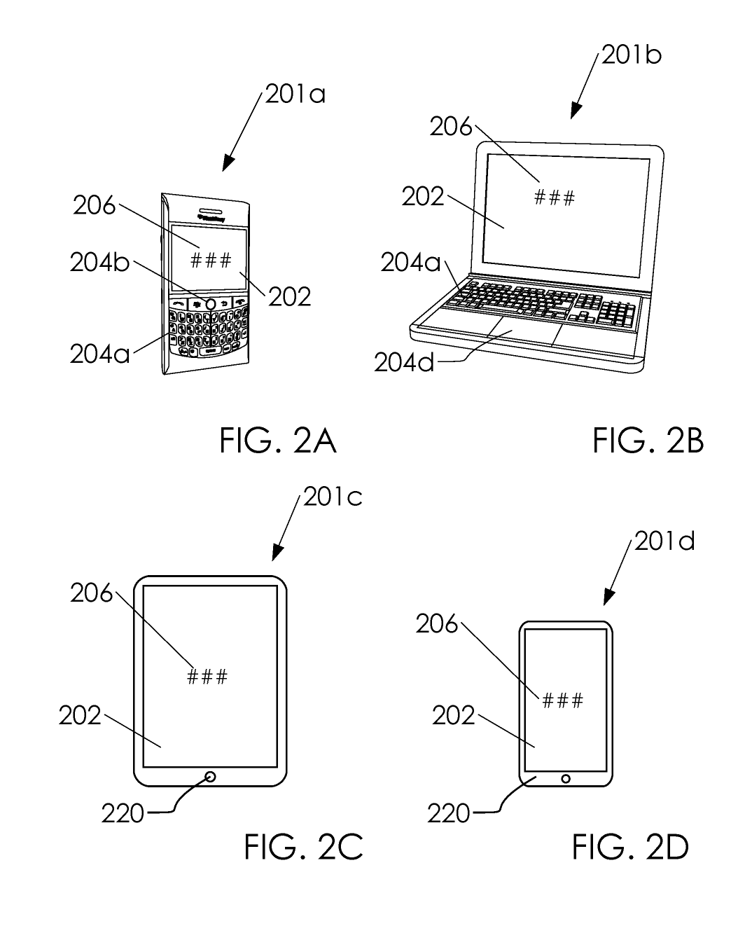

FIGS. 2A, 2B, 2C and 2D illustrate a perspective overview of a mobile phone 201a, a personal computer 201b, a tablet 201c, and a smartphone 201d.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said improved messaging system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

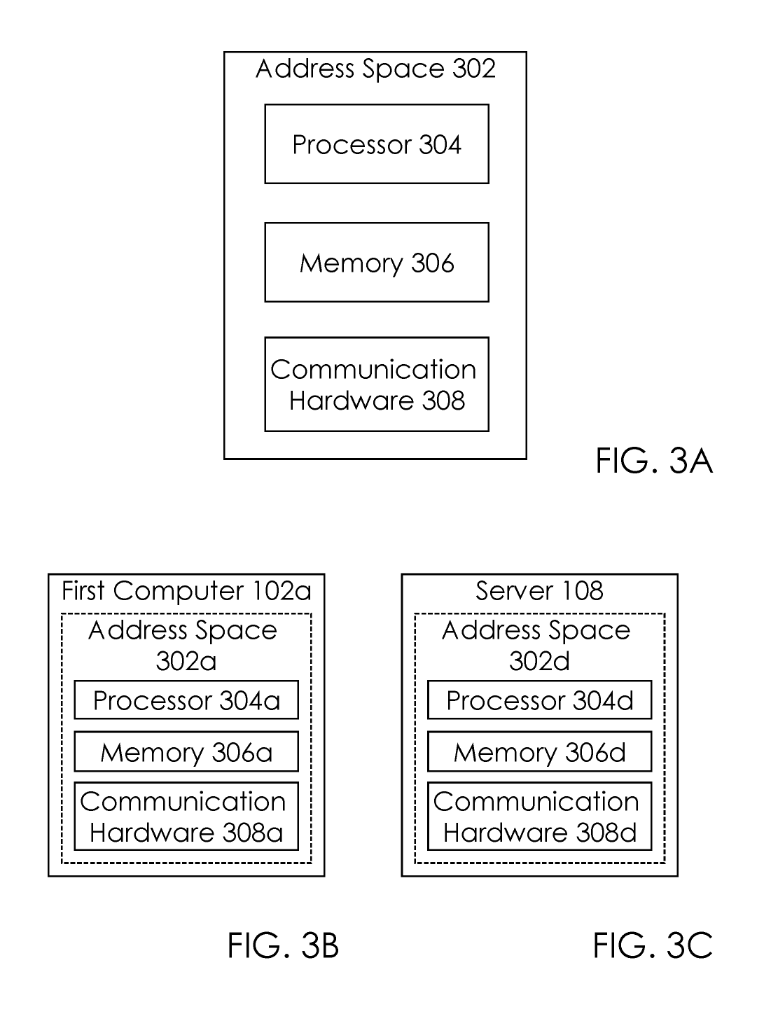

FIGS. 3A, 3B and 3C illustrate an address space 302 within said one or more computers, an address space 302a and an address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

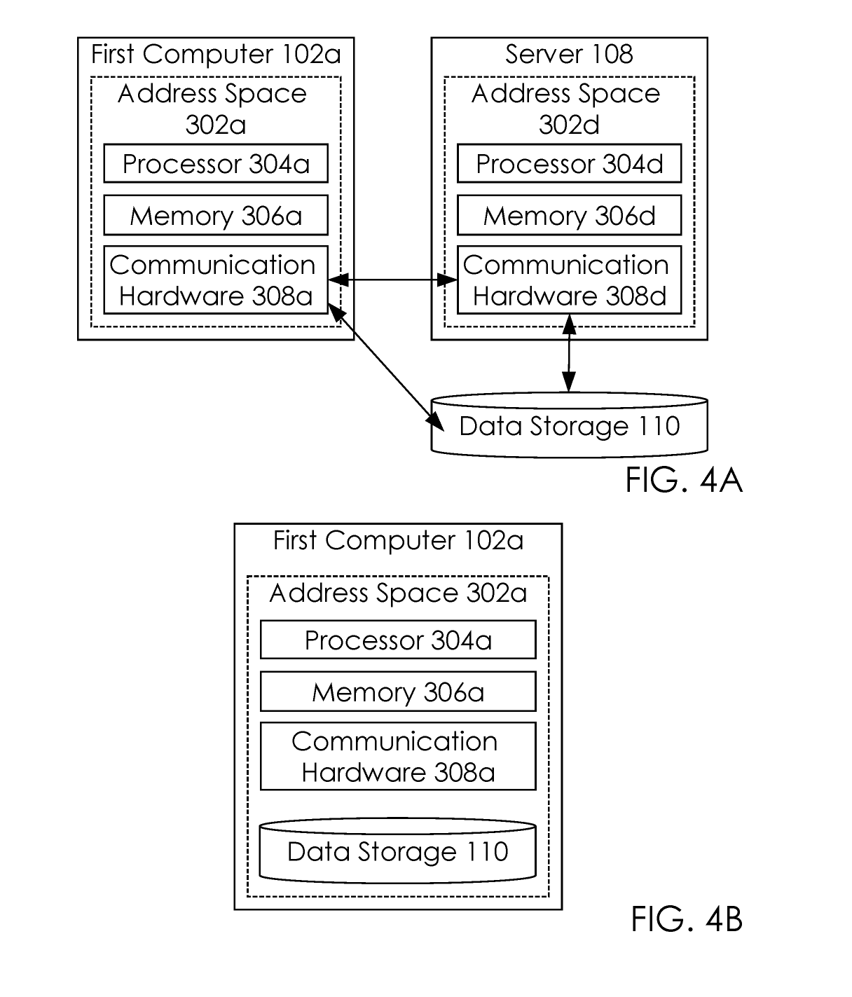

FIGS. 4A and 4B illustrate two embodiments for collecting and storing data with said improved messaging system 100; a first embodiment with a flow diagram between said first computer 102a and said server 108, and a second embodiment comprising of just said first computer 102a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers, which may speed up data communications by said improved messaging system 100. In another embodiment, said data can be stored temporarily on said data storage 110 and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110. Thus, said first computer 102a can operate without a data connection out to said server 108 while performing said system and method for field capture of data.

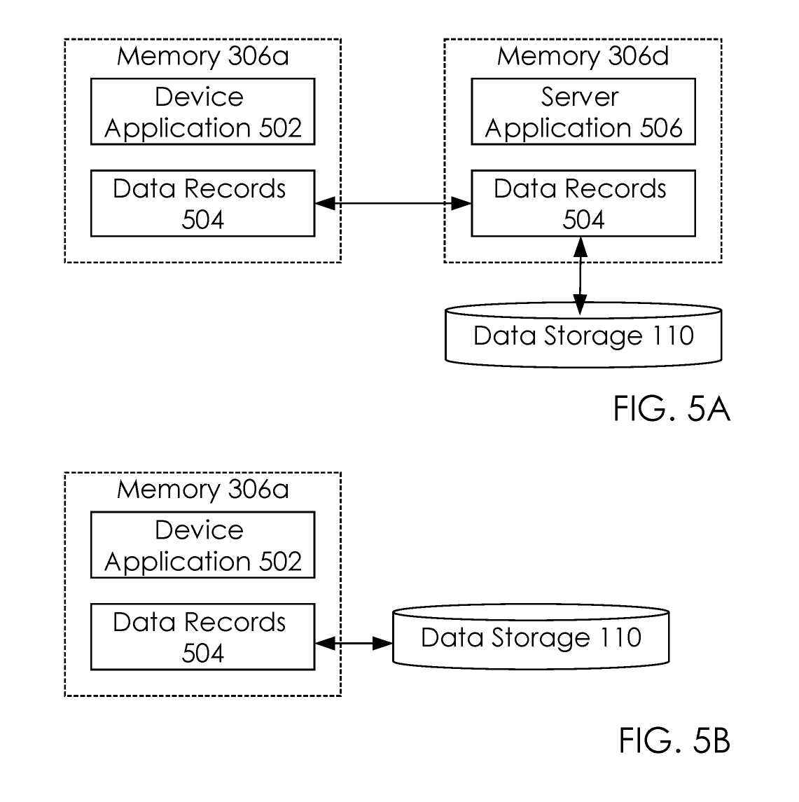

FIGS. 5A and 5B illustrate two examples of a flow diagram between said memory 306a and said memory 306d.

As illustrated in FIG. 5A, in one embodiment, said improved messaging system 100 can process said data 206 on said first computer 102a and/or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306a of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and/or said data 206 without the assistance of said server 108.

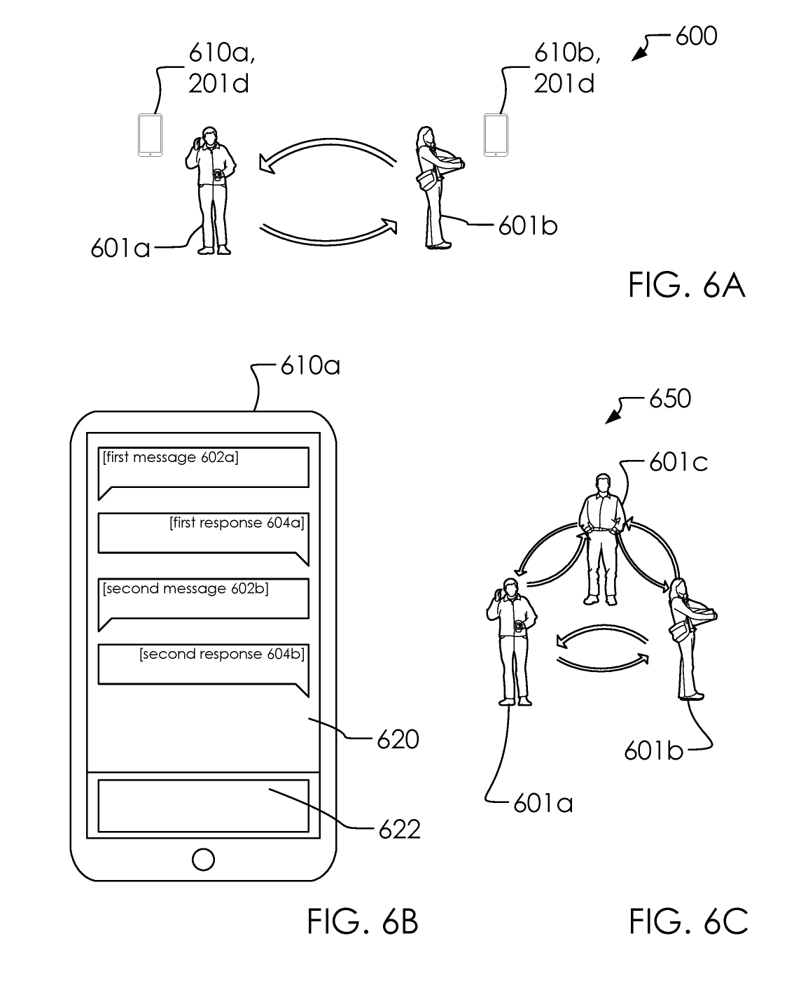

FIGS. 6A, 6B and 6C illustrate a first use diagram 600, a messaging dialog app 620, and a plurality of users 650.

In one embodiment, a first user 601a having a first mobile device 610a can communicate with a second user 601b having a second mobile device 610b. In one embodiment, said first mobile device 610a and said second mobile device 610b can comprise one of said smartphone 201d. As is known in the art, messages can be passed back and forth between said plurality of users 650 between devices. In one embodiment, said first use diagram 600 can describe a round trip communication between said first user 601a and said second user 601b.

In one embodiment, said messaging dialog app 620 can comprise a plurality of messages (such as a first message 602a, a first response 604a, a second message 602b, and a second response 604b). In one embodiment, writing messages from one user to another can be done in a text entry area 622.

Here, as illustrated and known in the art, said first user 601a has sent said first message 602a and said second message 602b and said second user 601b has responded with said first response 604a and said second response 604b.

In one embodiment, said plurality of users 650 can comprise said first user 601a, said second user 601b, and said third user 601c.

Said improved messaging system 100 can comprise a social network feature wherein, said plurality of users 650 store profiles and information related to one another and have preset sharing settings relative to one another, as is known in the art. For example, in one embodiment, said first user 601a can comprise a list of favorite friends such as said third user 601c and one or more among said plurality of users 650.

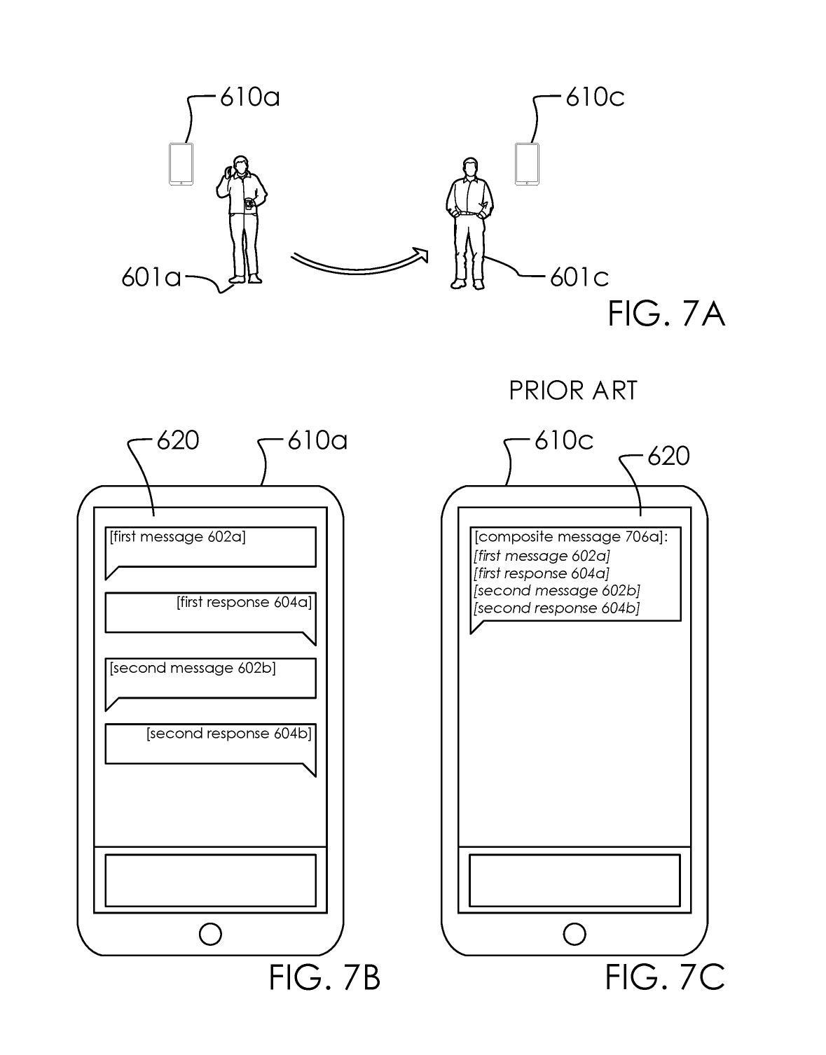

FIGS. 7A, 7B and 7C illustrate said first use diagram 600 with said first user 601a and said third user 601c, said first mobile device 610a and a prior art rendering of said third mobile device 610c.

In one embodiment, where said first user 601a wishes to share a string of messages to a third party (that is separate from said second user 601b), he can select a range of messages and forward them to another user (such as said third user 601c) as one or more combined messages. In one embodiment, said messaging dialog app 620 is not configured to maintain formatting and Meta data. Instead, a range of messages are combined into a composite message 706a and sent as a larger single message.

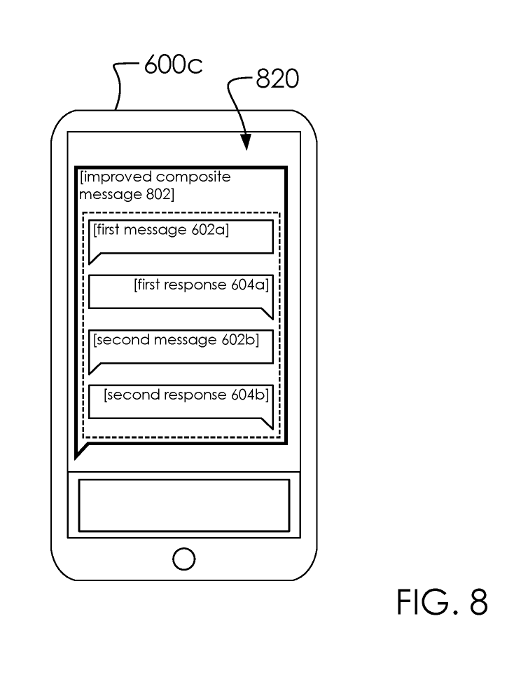

FIG. 8 illustrates a hypothetical improvement to message thread forwarding within an messaging application 820.

In one embodiment, said messaging application 820 can capture a one or more among said messaging dialog app 620 into a composite message 802, as illustrated and discussed below. In one embodiment, said messaging application 820 can be expressed as a first CM 802a, a second CM 802b, etc., not illustrated here.

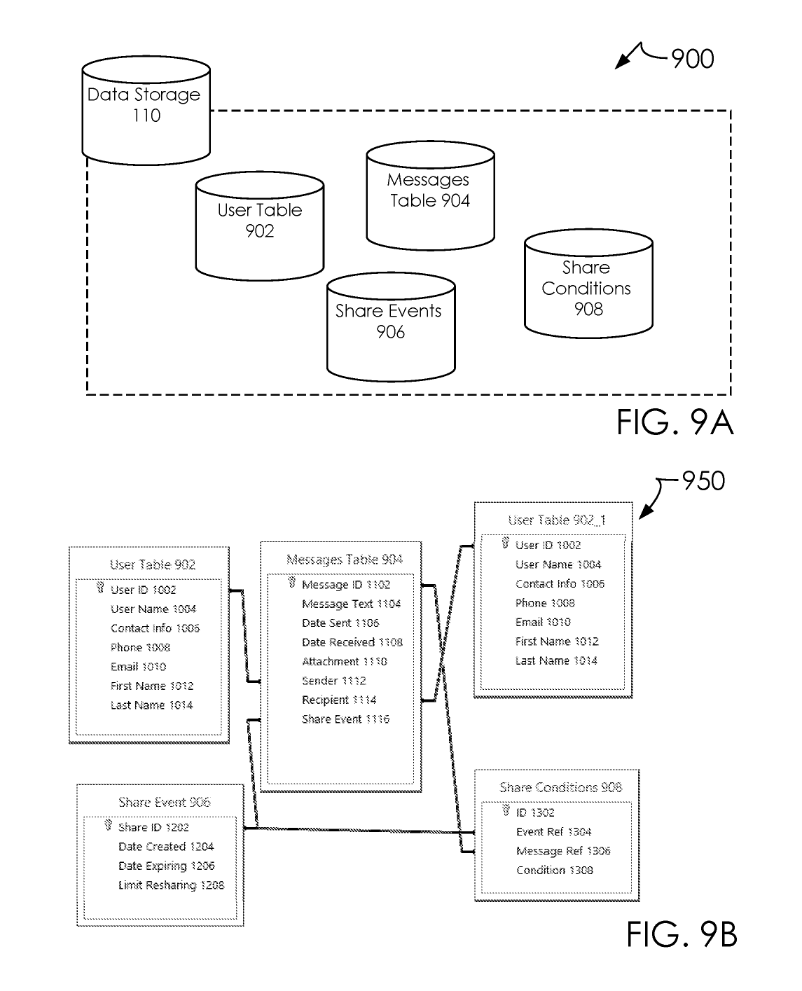

FIGS. 9A and 9B illustrate sub-tables diagram 900 and a field relationships diagram 950.

In one embodiment, said sub-tables diagram 900 can comprise subparts of said data storage 110, which can comprise a User Table 902, a Messages Table 904, a Share Events 906, and a Share Conditions 908.

In one embodiment, said field relationships diagram 950 can comprise a relationship between said subparts of said data storage 110, as illustrated and described.

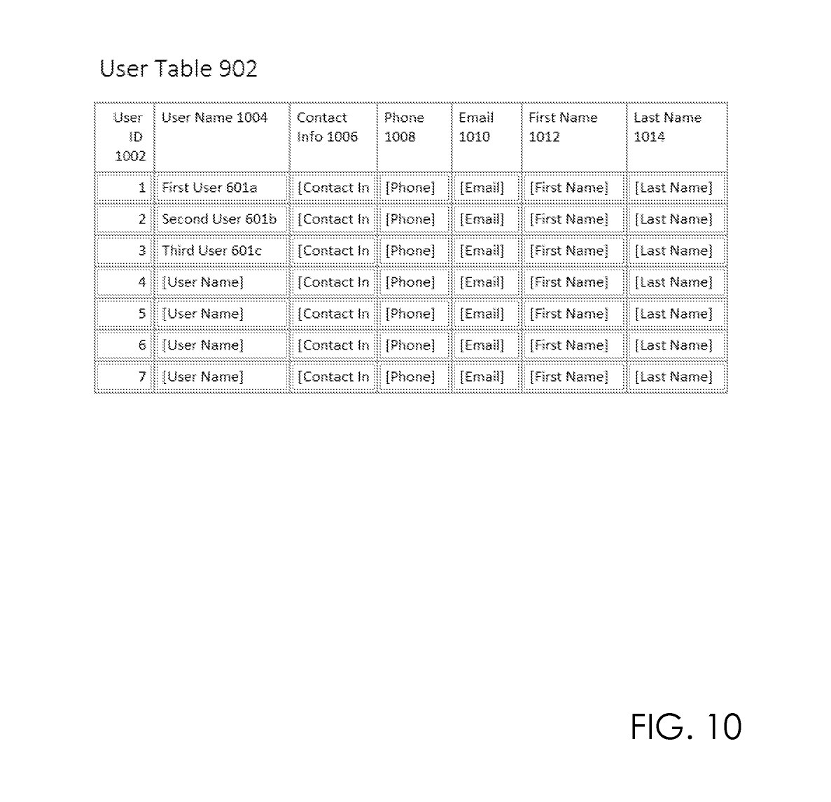

FIG. 10 illustrates said User Table 902.

In one embodiment, said User Table 902, a database table, can comprise a plurality of fields such as an User ID 1002, an User Name 1004, a Contact Info 1006, a Phone 1008, an Email 1010, a First Name 1012, and a Last Name 1014. In one embodiment, said User ID 1002 can comprise a unique identifier for each record in said User Table 902. In one embodiment, said User Name 1004 can comprise a unique alias of each user in said messaging application 820. In one embodiment, several fields (such as said Contact Info 1006, said Phone 1008, said Email 1010, said First Name 1012, and said Last Name 1014) can comprise user information fields which can be used for user identification and communication as known in the art.

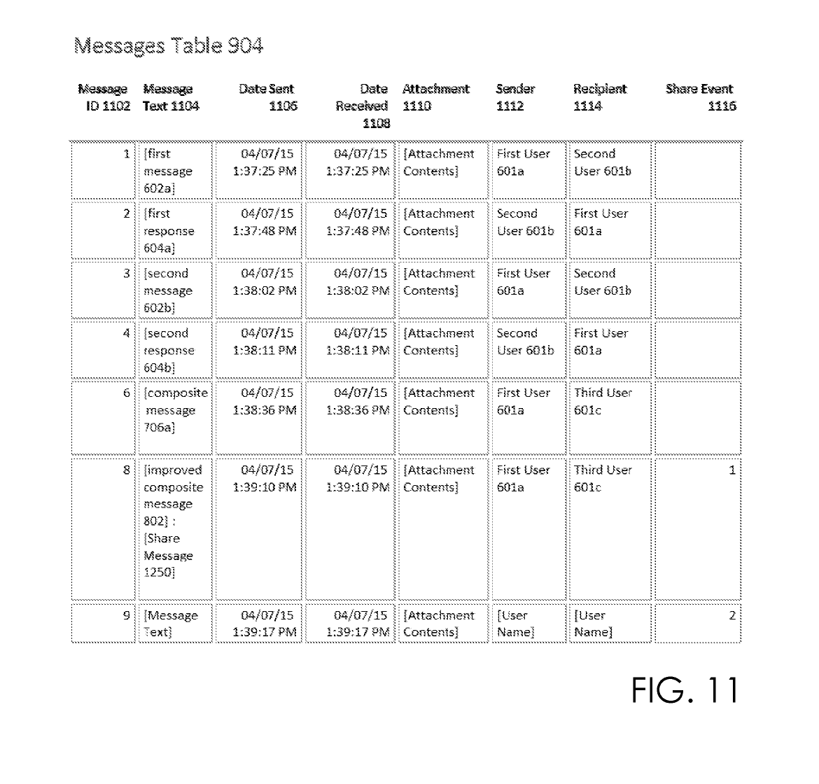

FIG. 11 illustrates said Messages Table 904.

In one embodiment, said Messages Table 904, a database table, can comprise a plurality of fields such as a Message ID 1102, a Message Text 1104, a Date Sent 1106, a Date Received 1108, an Attachment 1110, a Sender 1112, a Recipient 1114, and a Share Event 1116. In one embodiment, said Message ID 1102 can comprise a unique identifier of each field in said Messages Table 904. In one embodiment, said Message Text 1104 can comprise a message to be delivered from said Sender 1112 to said Recipient 1114. In one embodiment, said Date Sent 1106 and said Date Received 1108 can track a time a message is sent and received between said plurality of users 650. In one embodiment, said Attachment 1110 can comprise a binary file (such as a picture, video, or similar) attached to a message between said plurality of users 650. In one embodiment, said Attachment 1110 can comprise no attachments or a one or more of binary file attachments. In one embodiment, said Sender 1112 and said Recipient 1114 can each comprise a reference to one among the fields in said User Table 902; where, said Sender 1112 is a sender of a message and said Recipient 1114 comprises a recipient of a message. In one embodiment, said Share Event 1116 can comprise a cross reference to a record in Share Events 906, and the presence of a record in said Share Event 1116 means that said Sender 1112 has sent one of said composite message 802 to said Recipient 1114.

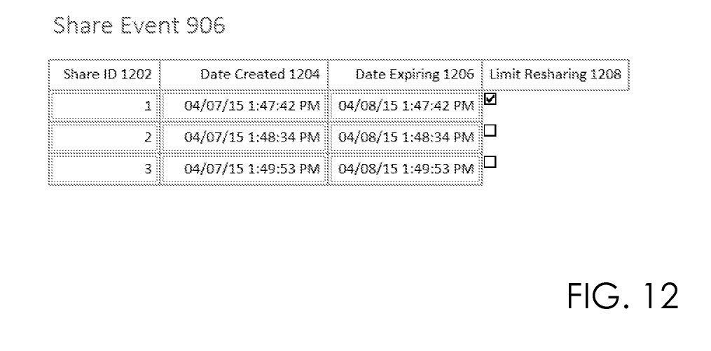

FIG. 12 illustrates said Share Events 906.

In one embodiment, said Share Events 906, a database table, can comprise a plurality of fields such as a Share ID 1202, a Date Created 1204, a Date Expiring 1206, and a Limit Resharing 1208. In one embodiment, said Share ID 1202 can comprise a unique identifier for records in said Share Events 906. In one embodiment, said Date Created 1204 and said Date Expiring 1206 can comprise date and time stamps of the time a record is created and a date where it will be deleted from said messaging application 820. In one embodiment, said Limit Resharing 1208 can comprise a flag (yes/no, true/false or similar flag) which is used to determine whether said third mobile device 610c can share said composite message 802 with another user.

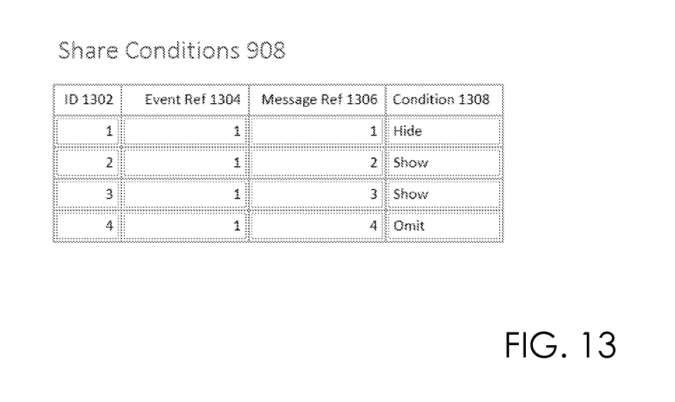

FIG. 13 illustrates said Share Conditions 908.

In one embodiment, said Share Conditions 908, a database table, can comprise a plurality of fields such as an id 1302, an Event Ref 1304, a Message Ref 1306 and a Condition 1308. In one embodiment, said id 1302 can comprise a unique identifier for records in said Share Conditions 908. In one embodiment, said Event Ref 1304 can comprise a cross reference to said Share ID 1202 in said Share Events 906. In one embodiment, said Message Ref 1306 can comprise a cross reference to said Message ID 1102 in said Messages Table 904. In one embodiment, said Condition 1308 can comprise a flag to indicate a nature of and amount of information being shared, as will be described further to come.

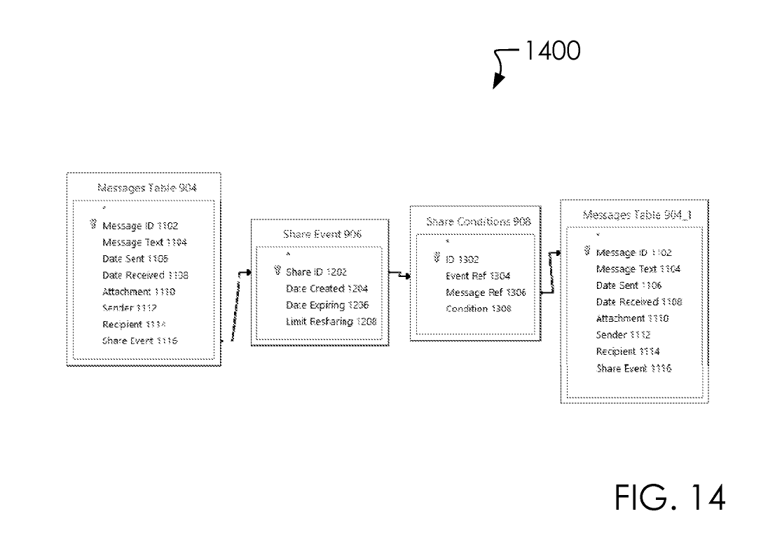

FIG. 14 illustrates a share query tables 1400.

As illustrated here, there is a one to many relationship between the tables while moving from left to right. This may be configured without this one to many relationship between said Messages Table 904 and said Share Events 906 in different systems.

In one embodiment, said share query tables 1400 can comprise a query being run on said data storage 110. In one embodiment, user (such as said Messages Table 904) can share a one or more messages in said Messages Table 904 with said Recipient 1114; wherein, a record can be created in said Share Events 906 and a cross reference to said Share ID 1202 can be stored in said Share Event 1116. In one embodiment, said Date Created 1204 and said Date Expiring 1206 can be updated at the time of creating a Share Events 906. In one embodiment, where said Date Expiring 1206 is empty, a record associated with said Share Events 906 does not expire. Otherwise, that record should expire according to the date stamp stored in said Date Expiring 1206.

In one embodiment, said Share Conditions 908 can comprise a cross reference table linking a shared record from said Share Events 906 with a one or more records in said Messages Table 904. Here, said Messages Table 904 is represented twice in this query with a second copy of the table shown as “Messages Table 904_1”. Accordingly, said Share Conditions 908 has two references including said Event Ref 1304 related to said Share Events 906 and said Message Ref 1306 associated with said Message ID 1102 of said Messages Table 904. In one embodiment, said Condition 1308 can dictate a condition of sharing a record in said Messages Table 904.

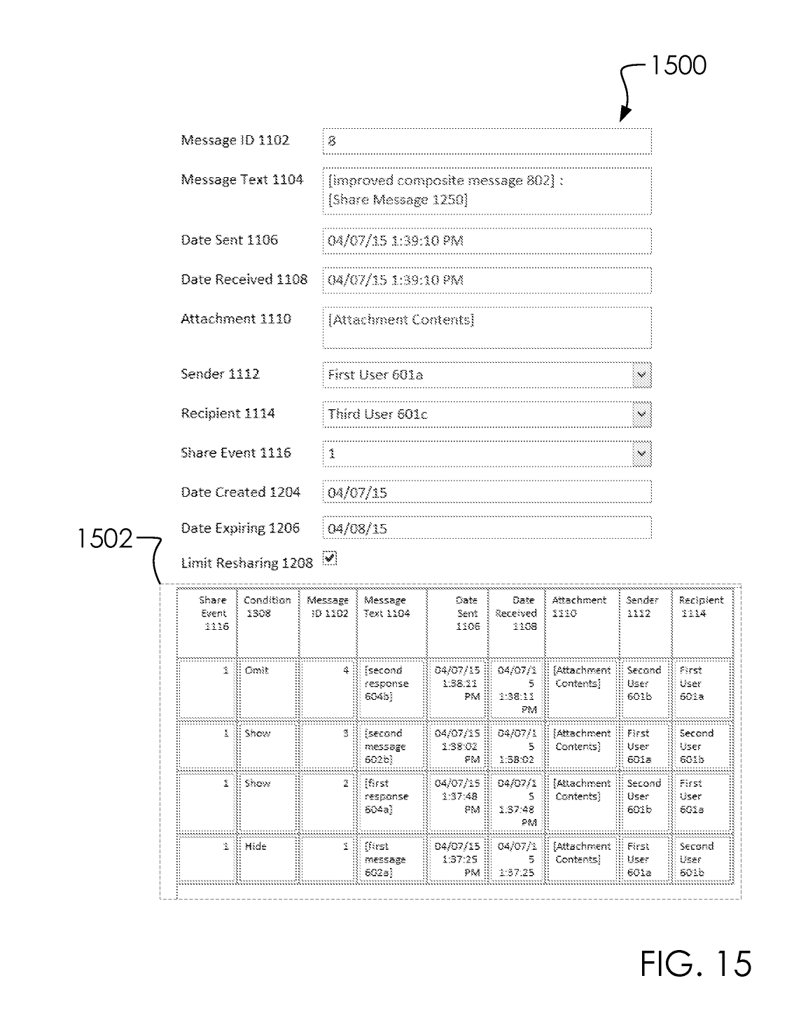

FIG. 15 illustrates a composite message data 1500.

In one embodiment, said composite message data 1500 can comprise a data from said data storage 110, including all or a portion of said User Table 902, said Messages Table 904, said Share Events 906 and said Share Conditions 908. Said composite message data 1500 can represent a portion of data from said share query tables 1400 and in said messaging application 820. In one embodiment, said composite message data 1500 represents data that can be shared between said plurality of users 650.

In one embodiment, said 1500 can comprise all the data in said Messages Table 904, said Date Created 1204, said Date Expiring 1206, said Limit Resharing 1208, and a submessages 1502. In one embodiment, said submessages 1502 can comprise data which has been collected from said share query tables 1400.

Said composite message data 1500 can comprise data sent from said Sender 1112 to said Recipient 1114 when said messaging application 820 is engaged to share a message thread. In one embodiment, said Sender 1112 may choose to send four messages to said Recipient 1114; wherein, said Share Conditions 908 comprises four records to said Message ID 1102 in said Messages Table 904; therefore, said submessages 1502 shows four messages where said Message ID 1102 equals to the values in the set {1, 2, 3, and 4}.

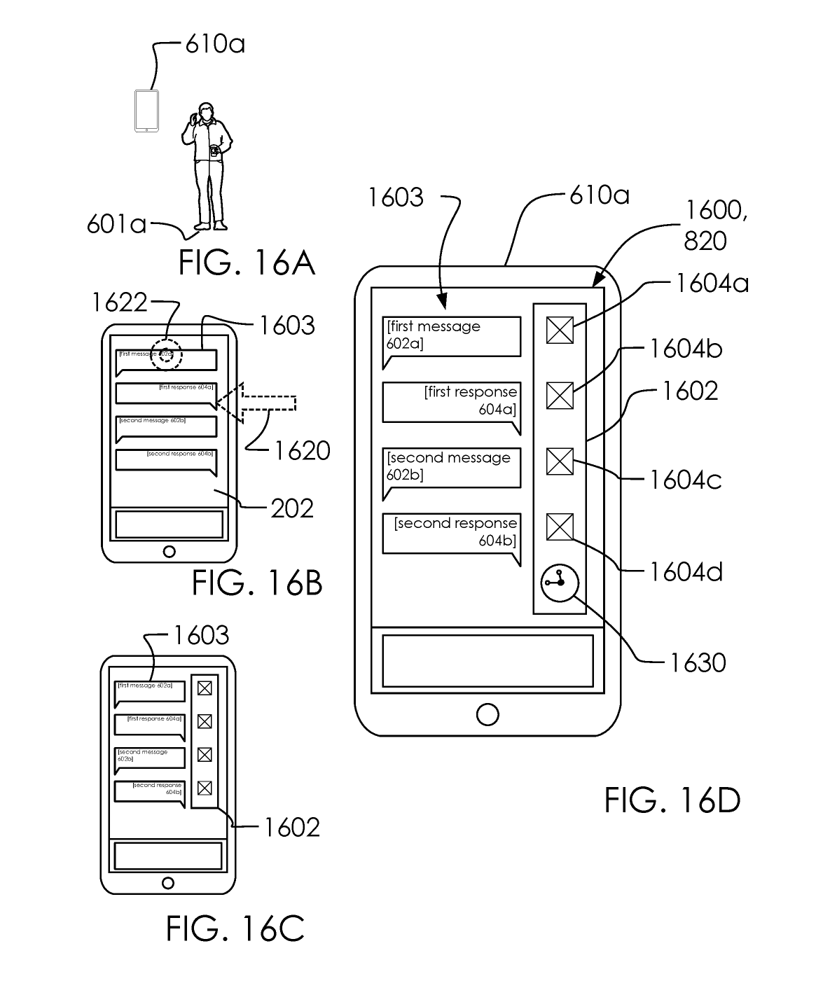

FIGS. 16A, 16B, 16C and 16D illustrate said first user 601a, and three views of a message selection interface 1600 of said messaging application 820 on said smartphone 201d.

In one embodiment, said message selection interface 1600 can be engaged by swiping a portion of said screen 202. For example, in one embodiment, said one or more messages 1603 (which can comprise message boxes including said first message 602a, et. al.) can be exposed using a swiping motion 1620 to expose a selection bar 1602, as illustrated in FIGS. 16B-16C. In another embodiment, said selection bar 1602 can be exposed by using a long press 1622 on a one or more of said one or more messages 1603.

In one embodiment, said message selection interface 1600 can comprise a portion of said messaging application 820. In one embodiment, said selection bar 1602 can comprise a plurality of selection options including a first selection option 1604a, a second selection option 1604b, a third selection option 1604c, and a fourth selection option 1604d. In one embodiment, said plurality of selection options can be altered and encoded as illustrated and described below.

In one embodiment, said selection bar 1602 can comprise a time selection option 1630. In one embodiment, said time selection option 1630 can comprise an option to select all messages between a start time and an end time, rather than selecting each and every message between those times.

The one or more messages 1603 can comprise messages selected from among text, images, animated images, emoji, audio files, 3D images, emails or binary files.

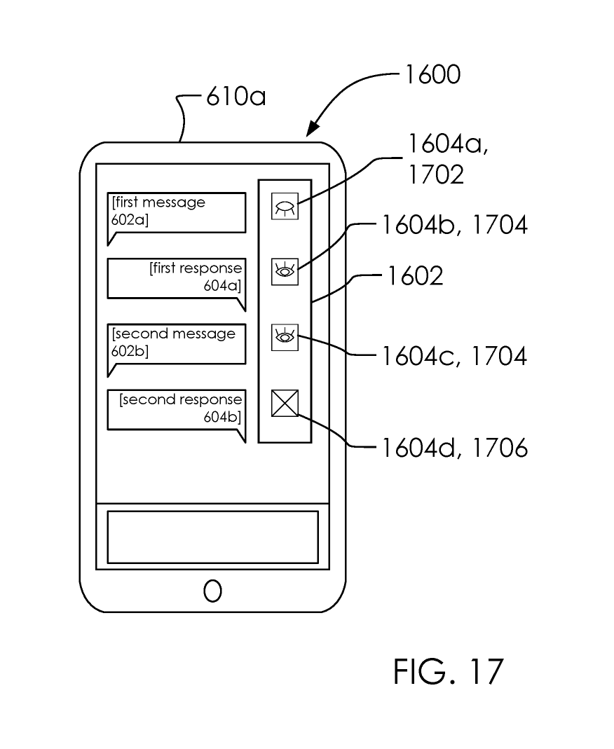

FIG. 17 illustrates said message selection interface 1600 in different configurations.

In one embodiment, said plurality of selection options can be altered to correspond to options in said Condition 1308 of said Share Conditions 908. For example, in one embodiment, said plurality of selection options can be changed between “show” (illustrated as a show icon 1704), “hide” (illustrated as a hidden icon 1702) or “omit” (illustrated as a omit icon 1706). Accordingly, here, said first user 601a has swiped said messaging application 820 to expose said selection bar 1602, altered said selection bar 1602 to have said first message 602a hidden (with said hidden icon 1702), said first response 604a and said second message 602b shown (with said show icon 1704), and said second response 604b as omitted (with said omit icon 1706. In one embodiment, said omit icon 1706 can comprise a default condition of each message when exposing said selection bar 1602. In one embodiment, said plurality of selection options can be altered by tapping said plurality of selection options, as is known in the art.

In this sense, said messaging application 820 can be used to redact information which may not be suitable for a target audience. For example, said first selection option 1604a can be kept hidden and said fourth selection option 1604d can be omitted entirely.

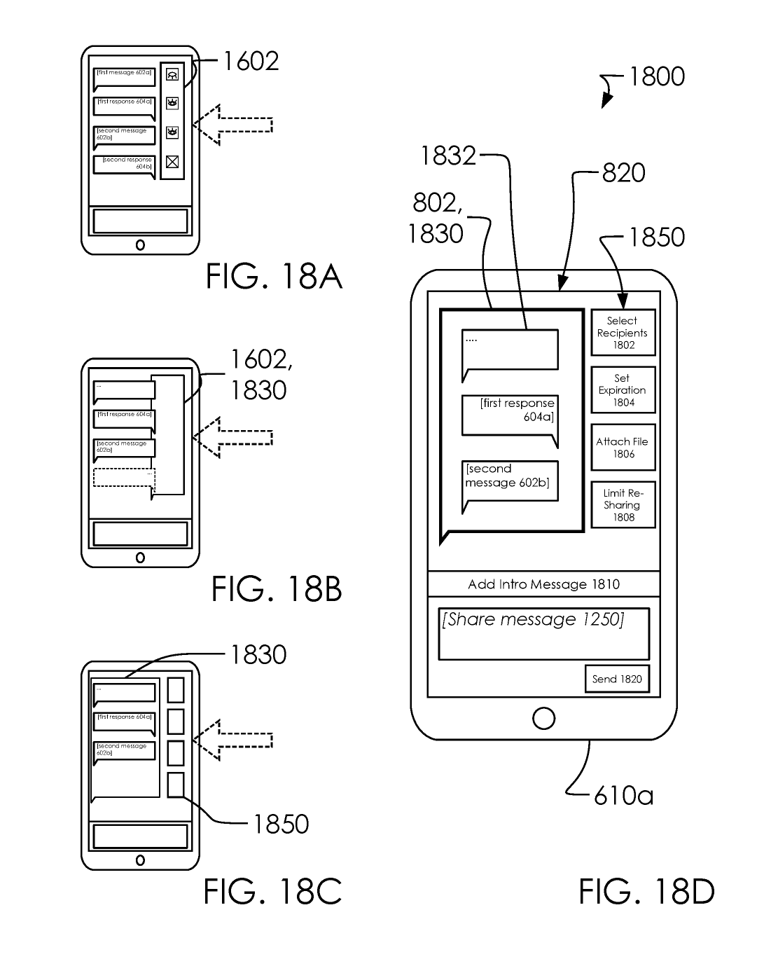

FIGS. 18A, 18B, 18C and 18D illustrate three figures in transition between said message selection interface 1600 and a message sharing interface 1800, and one figure of said message sharing interface 1800.

In one embodiment, swiping a portion of said screen 202 after finishing with said message selection interface 1600 can cause said messaging application 820 to transition into said message sharing interface 1800. For example, in one embodiment, swiping left on said screen 202 can: cause said plurality of selection options to disappear; said one or more messages 1603 to be shown, hidden or omitted; said selection bar 1602 to transform into a composite message box 1830; and a one or more buttons 1850 to appear to the right of said composite message box 1830. In one embodiment, those among said one or more messages 1603 which are marked to be hidden can be replaced with a hidden message 1832 and those marked as omitted can disappear.

In one embodiment, said message sharing interface 1800 can comprise a composite message box 1830 comprising a portion of said one or more messages 1603 having been filtered according to said selection bar 1602.

In one embodiment, said one or more buttons 1850 can comprise a select recipients 1802, a set expiration 1804, an attach file 1806 and a limit re-sharing 1808. Further, said select recipients 1802 can comprise an add intro message 1810 and a send button 1820, as is known in the art.

In one embodiment, said select recipients 1802 can comprise a button which opens a dialog for selecting one or more among said plurality of users 650 with whom to share said composite message box 1830.

In one embodiment, said set expiration 1804 can opens a dialog for selecting an expiration date of a shared message.

In one embodiment, said attach file 1806 can allow a user to attach a binary file, such as a picture or video, as discussed above.

In one embodiment, said limit re-sharing 1808 can limit the redistribution of said composite message box 1830. Where said limit re-sharing 1808 is selected, said composite message box 1830 can be restricted for sharing to those users selected in said select recipients 1802 and to no other users. Further, where said limit re-sharing 1808 is selected, said messaging application 820 on other devices can have the screen share, screen shot or other screen data capturing devices disabled for that dialog. This feature is intended to protect users and build confidence when sharing information.

In one embodiment, said messaging application 820 can be used for sending a portion of an email thread forward as a complete or redacted thread in the same manner as said composite message 802. Similar collection, redacting, omitting and summarizing of thread information may be conducted prior to sending such said composite message 802 in this context.

Said composite message includes a hidden message comprising a placeholder within a composite message box. the hidden message comprises a portion of the composite message which the first user wished to omit but to include a placeholder. the composite message box is displayed on a computer belonging to the second user with the contents of the composite message.

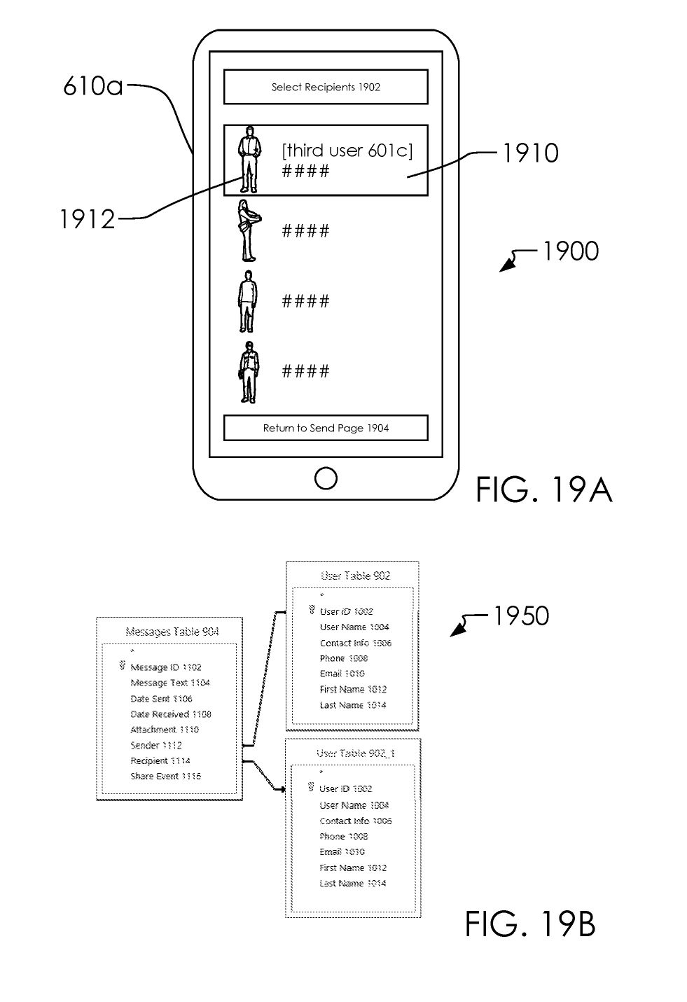

FIGS. 19A and 19B illustrate a select recipients interface 1900 and a data table view of recipient fields 1950.

In one embodiment, the select recipients interface 1900 can comprise a well-known user interface for selecting one or more records from a database table. For example, in one embodiment, the select recipients interface 1900 can comprise a Select Recipients menu 1902 comprising a list of the plurality of users 650 along with data 1910 and icons 1912, as illustrated. Here, as illustrated, the third user 601c is selected and none other. However, in one embodiment, the Sender 1112 can select a plurality of the plurality of users 650. In one embodiment, the select recipients interface 1900 can comprise a Return to Send Page 1904 button which returns a user to the message sharing interface 1800 after selecting one or more among the plurality of users 650 to share a message with.

In one embodiment, as illustrated in FIG. 19B, the Recipient 1114 record can comprise a one to many relationship with the User ID 1002 of the User Table 902.

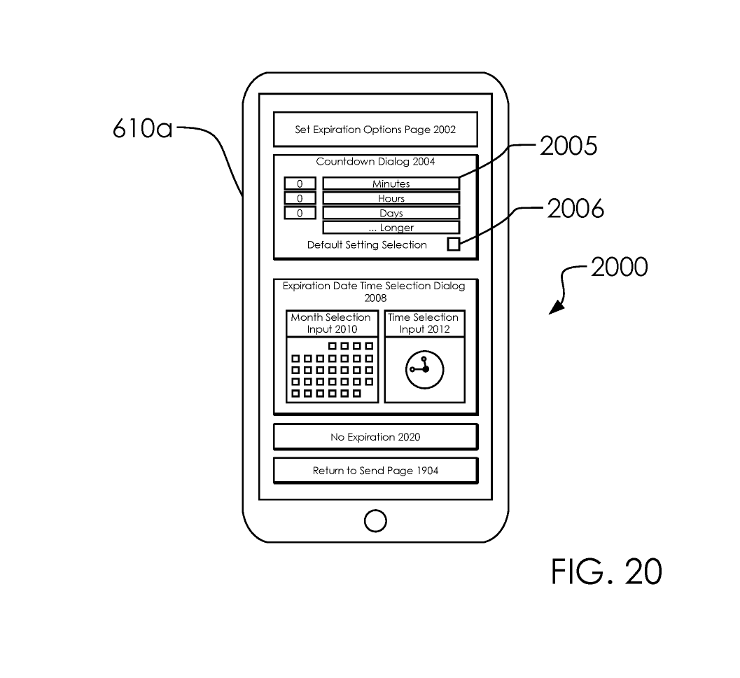

FIG. 20 illustrates a select expiration interface 2000.

In one embodiment, the select expiration interface 2000 can comprise a set expiration options page 2002 having a countdown dialog 2004 and an expiration date time selection dialog 2008. In one embodiment, the countdown dialog 2004 can comprise a duration picker 2005 for selecting a countdown length in a chosen unit, as is known in the art. In one embodiment, the countdown dialog 2004 can also comprise a Default Setting Selection 2006; wherein a user can select a the Default Setting Selection 2006 where the inputs of the duration picker 2005 should be the default share time for the messaging application 820. This data can be stored in the User Table 902, although it is not illustrated here. In one embodiment, the inputs of the duration picker 2005 can be calculated as added to the current time to set the Date Expiring 1206 of the Share Events 906.

In one embodiment, the expiration date time selection dialog 2008 can comprise a month selection input 2010 and a time selection input 2012 for setting the Date Expiring 1206 directly.

In one embodiment, the set expiration options page 2002 can comprise a no expiration button 2020 which can comprise a label such as “N/A”, “None” or similar. Wherein, use of the no expiration button 2020 can indicate that information shared will not expire.

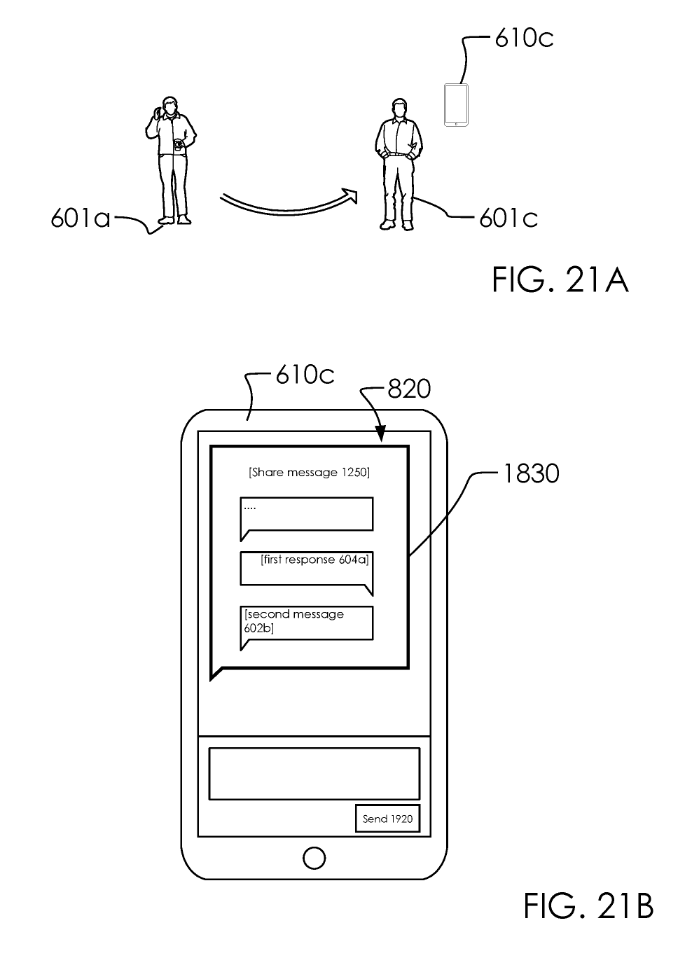

FIGS. 21A and 21B illustrate a portion of the plurality of users 650 and the messaging application 820 displaying the composite message box 1830.

In one embodiment, the third user 601c can receive the composite message box 1830 as formatted by the first user 601a. In one embodiment, the composite message box 1830 can be displayed on the third mobile device 610c as illustrated.

The one or more messages, a user profile information, the composite messages, and historical transactions are stored on the server.

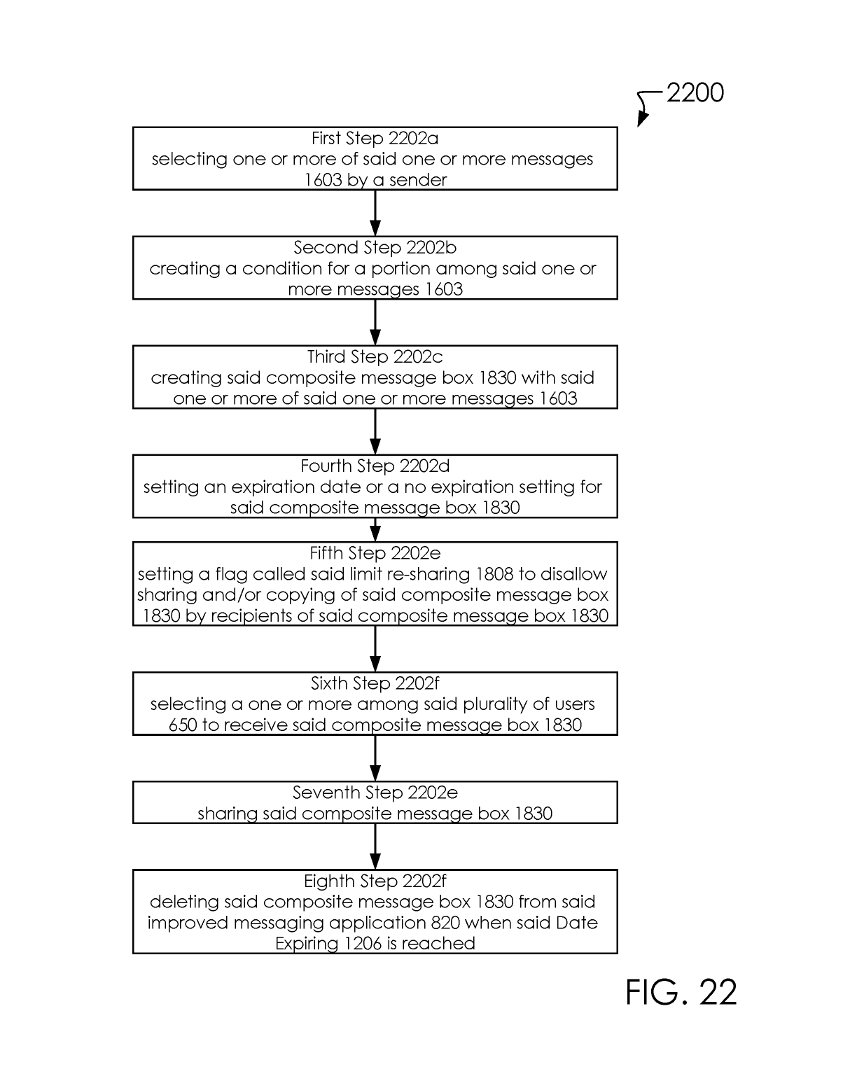

FIG. 22 illustrates a flow chart 2200.

In one embodiment, the flow chart 2200 can comprise a plurality of steps which can comprise a method of using the messaging application 820 and/or the improved messaging system 100. In one embodiment, the plurality of steps can comprise a first step 2202a, a second step 2202b, a third step 2202c, a fourth step 2202d, a fifth step 2202e, a sixth step 2202f, a seventh step 2202g, and an eighth step 2202h.

The first step 2202a can comprise: selecting one or more of the one or more messages 1603 by a sender. The second step 2202b can comprise: creating a condition for a portion among the one or more messages 1603. The third step 2202c can comprise: creating the composite message box 1830 with the one or more of the one or more messages 1603. The fourth step 2202d can comprise: setting an expiration date or the no expiration button 2020 for the composite message box 1830. The fifth step 2202e can comprise: setting a flag called the limit re-sharing 1808 to disallow sharing and/or copying of the composite message box 1830 by recipients of the composite message box 1830. The sixth step 2202f can comprise: selecting a one or more among the plurality of users 650 to receive the composite message box 1830. The seventh step 2202g can comprise: sharing the composite message box 1830. The eighth step 2202h can comprise: deleting the composite message box 1830 from the messaging application 820 when the Date Expiring 1206 is reached.

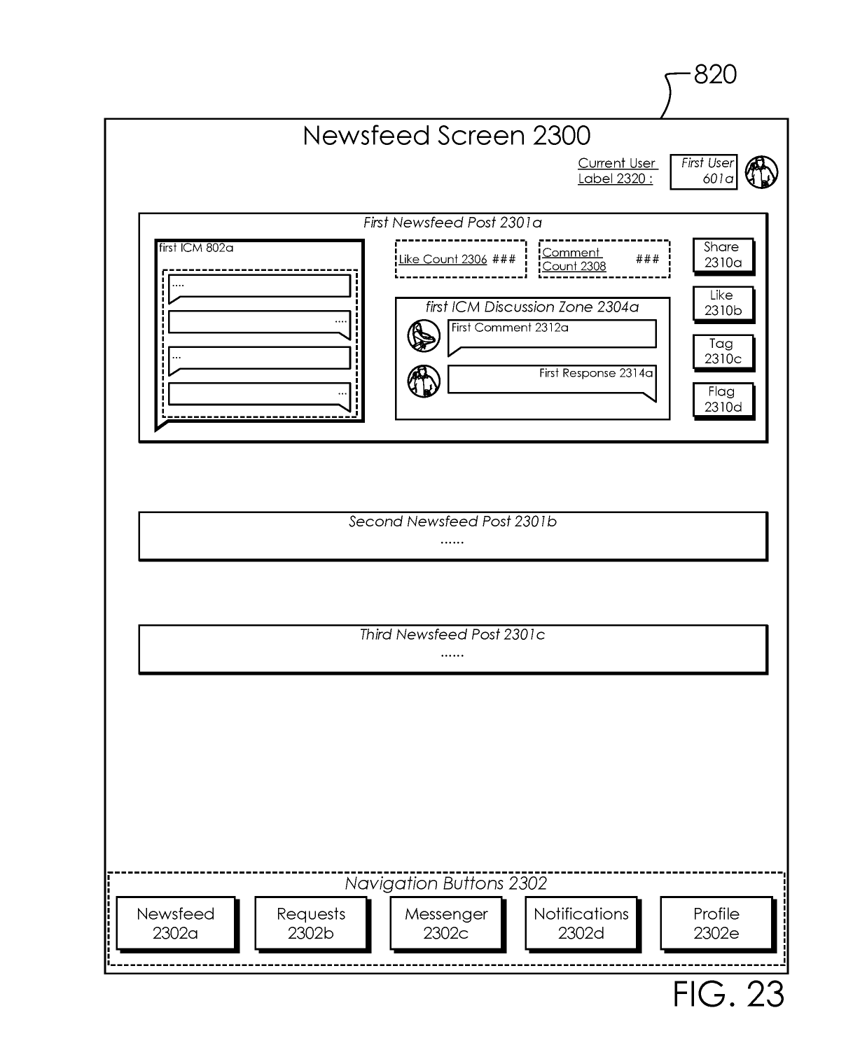

FIG. 23 illustrates a news feed screen 2300.

The messaging application 820 can comprise a navigation buttons 2302 which can comprise a newsfeed button 2302a, a requests button 2302b, a messenger button 2302c, a notifications button 2302d and a profile button 2302e. In one embodiment, the news feed screen 2300 can open in the messaging application 820 upon clicking the newsfeed button 2302a.

In one embodiment, the news feed screen 2300 can comprise a current user label 2320 to indicate which user is currently signed in; for example, the first user 601a is signed in FIG. 23. The news feed screen 2300 can further comprise a one or more newsfeed posts 2301 which can comprise a first newsfeed post 2301a, a second newsfeed post 2301b, and a second newsfeed post 2301b. In one embodiment, the one or more newsfeed posts 2301 can comprise information from one or more users among the plurality of users 650, as is known in the art. Here, the second newsfeed post 2301b and the third newsfeed post 2301c are empty so as to focus the discussion on the first newsfeed post 2301a.

In one embodiment, the one or more newsfeed posts 2301 can each comprise a discussion and posting of one among the composite message 802. For example, the first newsfeed post 2301a can comprise the first CM 802a, a first ICM discussion zone 2304a, a like count 2306, comment count 2308, a share button 2310a, a 2310b, a tag button 2310c, and a flag button 2310d. In one embodiment, the first ICM discussion zone 2304a can comprise a first comment 2312a and a first response 2314a.

The news feed screen 2300 can comprise some well-known features form other social networks such as: the like count 2306 adapted to track a number of times that the first newsfeed post 2301a has received a click on the like button 2310b; the comment count 2308 can comprise a number of comments left in the first ICM discussion zone 2304a; the share button 2310a allowing users to share the first newsfeed post 2301a; the tag button 2310c to tag someone or something associated with the first newsfeed post 2301a; and the flag button 2310d to indicate that an objectionable content is contained in the first newsfeed post 2301a.

Accordingly, the messaging application 820 can provided a news feed screen 2300 for the summary of activities by the plurality of users 650 and for a quick overview of activity on the platform.

In one embodiment, the messaging application 820 can be displayed in a web browser, the mobile phone 201a, the personal computer 201b, the tablet 201c and/or the smartphone 201d. indeed, the messaging application 820 can be accessed in traditional locations with access to the network 106.

In one embodiment, said messaging application 820 can comprise a social network software allowing said plurality of users 650 to connect and share information with one another. the messaging application allows users to post the composite messages to a newsfeed within the social network software.

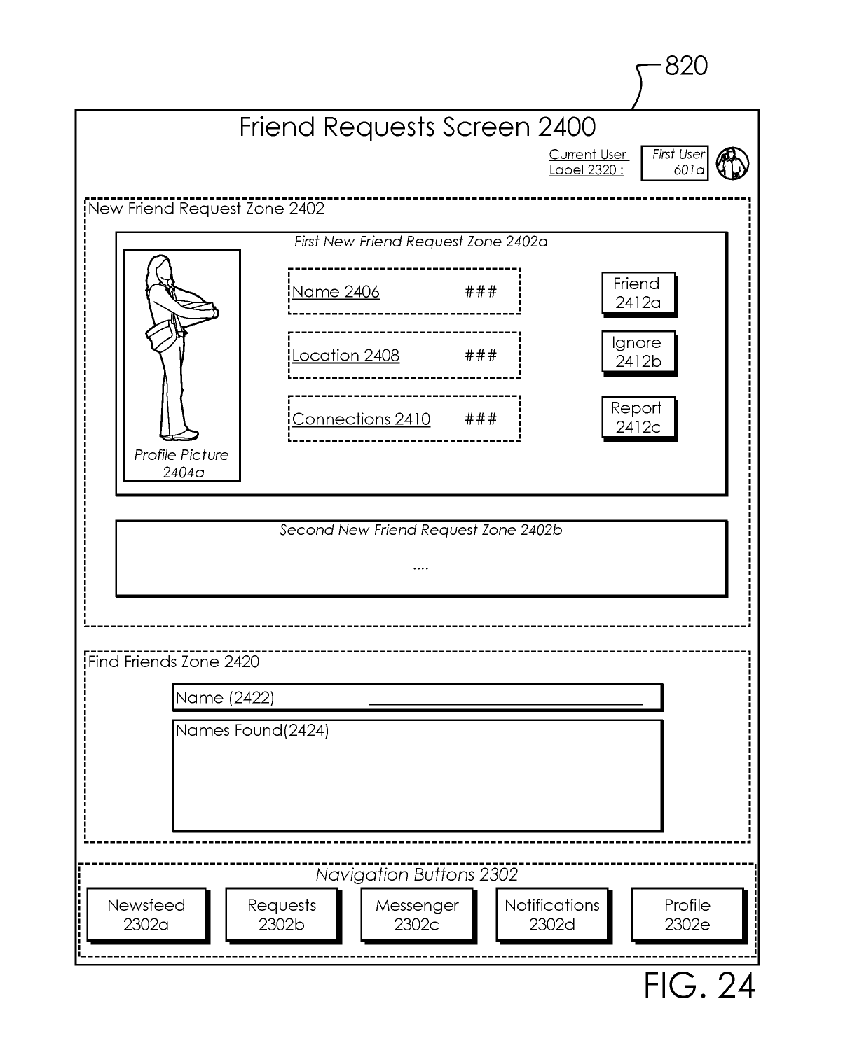

FIG. 24 illustrates a friend request screen 2400.

As is known in field, users among the plurality of users 650 can connect to one another through the friend request screen 2400. In one embodiment, the news feed screen 2300 can comprise a new friend request zones 2402 (which can comprise a first new friend request zone 2402a and a second new friend request zone 2402b) and a find friends zone 2420.

In one embodiment, the friend request screen 2400 can come up when a user clicks on the requests button 2302b. In one embodiment, each among the new friend request zones 2402 can comprise a profile picture 2404a, a name 2406, a location 2408, a connection 2410 a friend button 2412a, an ignore button 2412b, and a report button 2412c.

The friend request screen 2400 can comprise a name 2422 and a names found 2424. In one embodiment, the name 2422 can receive a query for searching a list of the plurality of users 650, wherein a portion of the results can be shown in the names found names found 2424.

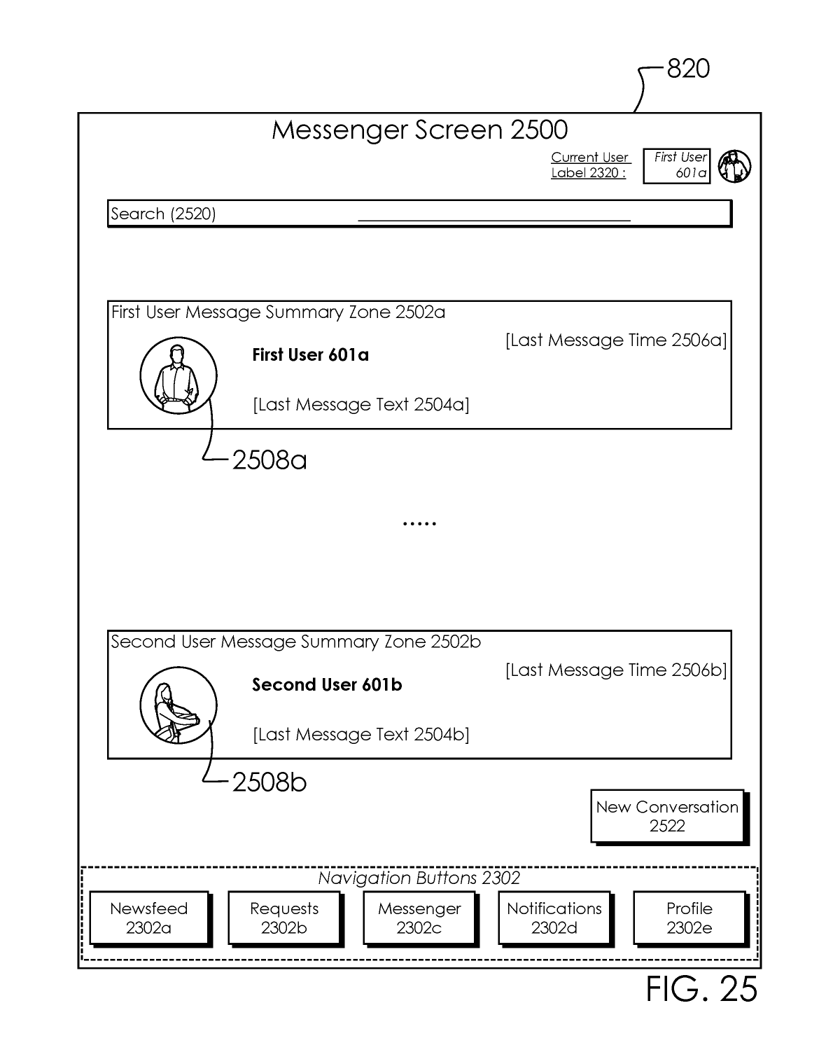

FIG. 25 illustrates a messenger screen 2500.

In one embodiment, the messaging application 820 can be adapted for displaying a 2502 (which can comprise a first user message summary zone 2502a and a second user message summary zone 2502b). In one embodiment, the first user message summary zone 2502a can comprise a last message text 2504a, a last message time 2506a, a profile CMge 2508a, and the User Name 1004 (shown as “first user 601a”). Likewise, the second user message summary zone 2502b can comprise a last message text 2504b, a last message time 2506b, a profile CMge 2508b, and the User Name 1004 (shown as “second user 601b”).

In one embodiment, clicking on one of the one or more conversations 2502 can load a messaging history between two users. In one embodiment, the search box 2520 can be used to search a messaging history. In one embodiment, a new conversation button 2522 can be used to start a new conversation.

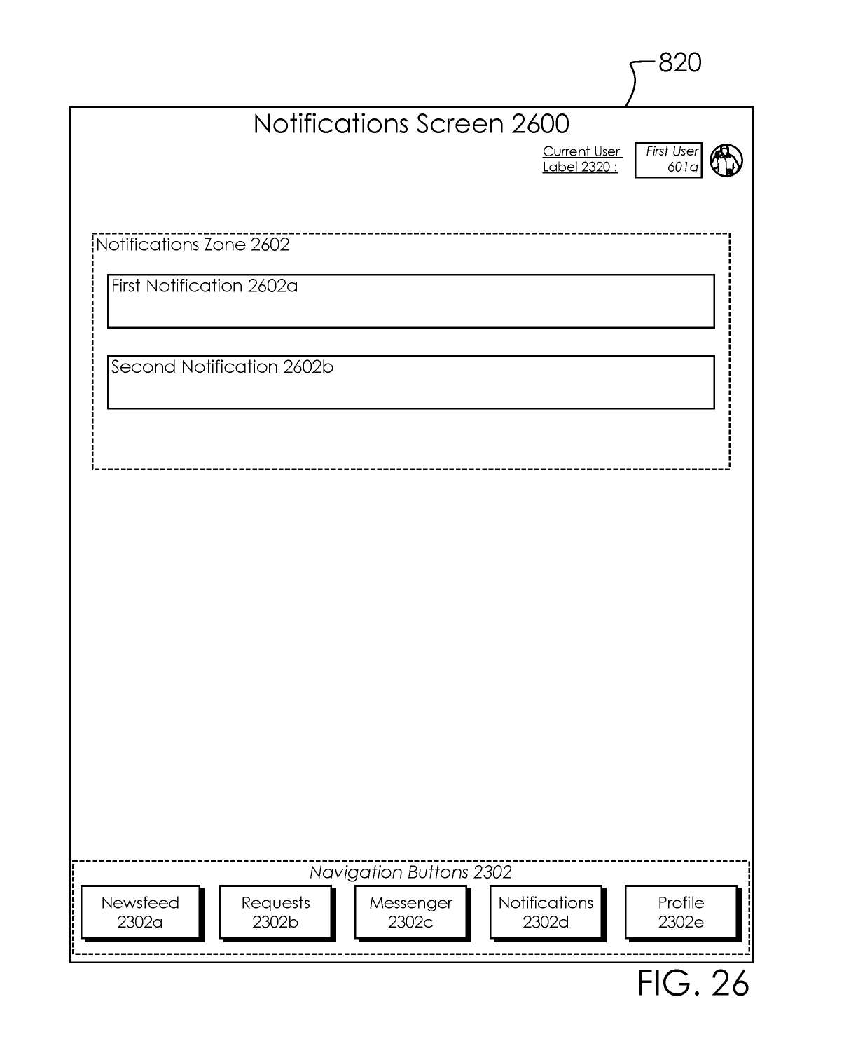

FIG. 26 illustrates a notifications screen 2600.

In one embodiment, the notifications screen 2600 can comprise a notifications zone 2602 which can comprise a first notification 2602a and a second notification 2602b.

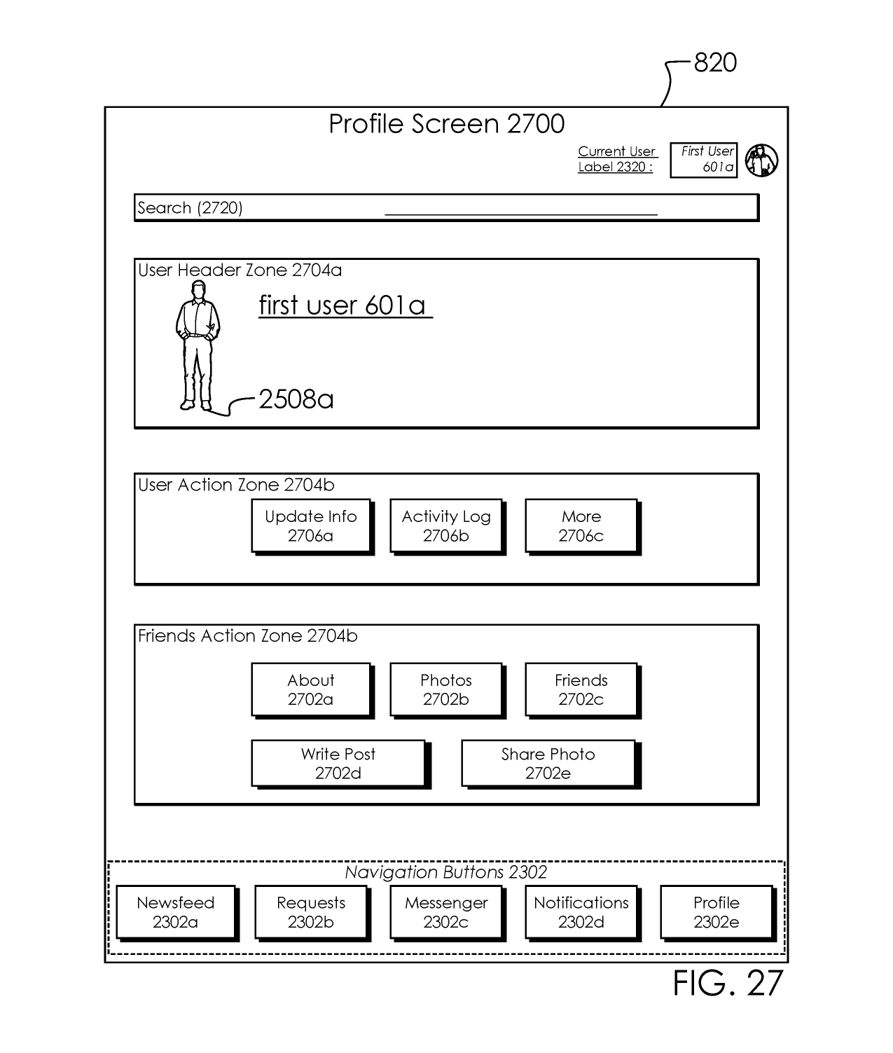

FIG. 27 illustrates a profile screen 2700.

The profile screen 2700 can be used, as is known in the art, to post a summary of a user and/or connect with a particular user.

The profile screen 2700 can comprise a content zones 2704. The content zones 2704 can comprise a user header zone 2704a, a user action zone 2704b, and a friend action zone 2704c. In one embodiment, the user header zone 2704a can comprise the profile CMge 2508a, and the User Name 1004 (here “first user 601a”); the user action zone 2704b can comprise an update info button 2706a, an activity log button 2706b, and a more button 2706c; and the friend action zone 2704c can comprise an about button 2702a, a photos button 2702b, a friends button 2702c, a write post 2702d, and a share photo 2702e.

As is known in the art, the update info button 2706a can allow a user to update his information such as biographical information; the activity log button 2706b can link to a list of activities; the more button 2706c can allow a user to see more options; the about button 2702a can allow another user to see more information about a user; the photos button 2702b can comprise photos of a user; the friends button 2702c can comprise a list of friends; the write post 2702d can comprise a link to write a new post; and the share photo 2702e can comprise a menu to share photos.

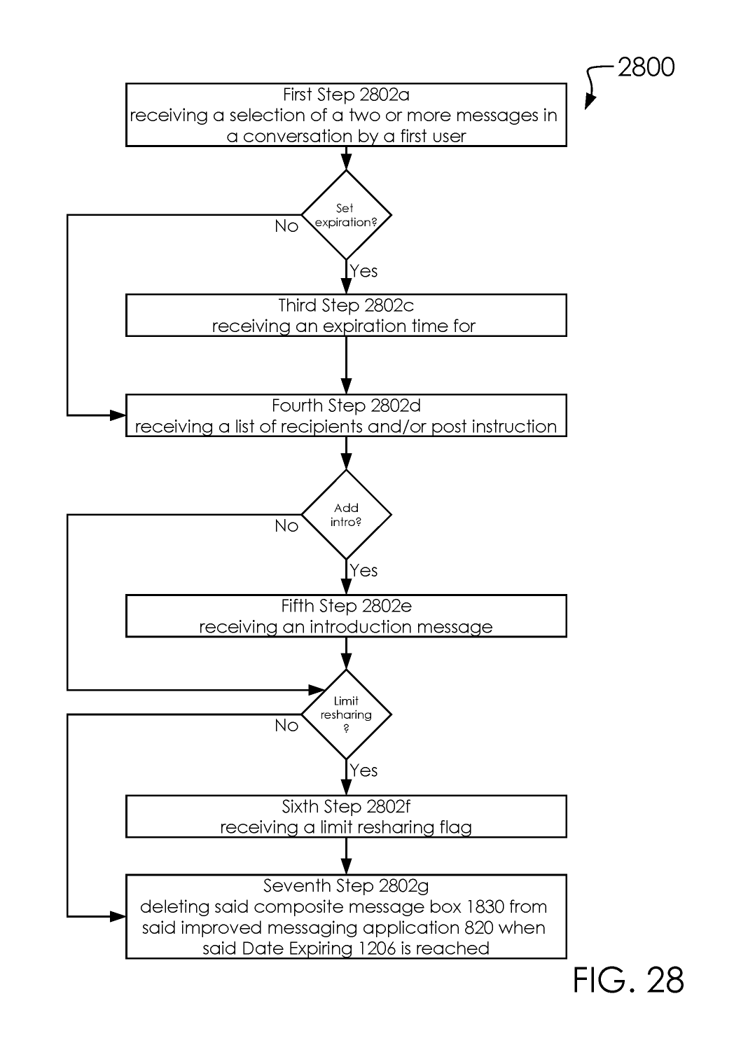

FIG. 28 illustrates a flow diagram 2800.

The flow diagram 2800 can comprise a first step 2802a, a second step 2802b, a third step 2802c, a fourth step 2802d, a fifth step 2802e, a sixth step 2802f and a seventh stem 2802g.

The flow diagram 2800 can describe a procedure for implementing and sharing the composite message 802. First, the system can receive a selection of two or more messages in a conversation; then, ask whether the user wants to set an expiration; then receive a list of recipients; then, ask if the user wants to add an introduction; then, ask if the user wants to limit resharing; and finally to delete the message when the expiration condition is reached.

In one embodiment, the fourth step 2802d can comprise either receiving a list of recipients or a post instruction. That is, that the messaging application 820 can receive an instruction to send the composite message 802 to individual users and/or to the news feed screen 2300 for general consideration by all users.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An apparatus, comprising:
at least one memory including a computer program code; at least one processor,
wherein said at least one memory and said computer program code are configured to, with said at least one processor, cause said apparatus at least to implement a messaging application;
said messaging application is in communication with a server over a network;
said messaging application is installed and running on a plurality of computers; a plurality of users conduct a plurality of conversations with one another through said messaging application;
each of said plurality of conversations comprising a one or more messages between a two or more among said plurality of users;
said plurality of users comprise at least a first user and a second user;
said plurality of conversations comprise at least a first conversation between said first user and said second user;
said messaging application creates a composite message from a selection by said first user of two or more messages within said first conversation; and
said messaging application provides a dialog for sending said composite message to one or more among said plurality of users.

2. The apparatus of claim 1, wherein:
said composite message further comprises an introduction message;
said introduction message is written by said first user and included with said composite message; and
said messaging application includes said introduction message with said composite message.

3. The apparatus of claim 1, wherein:
said composite message further comprises an expiration time;
said messaging application allows said composite message to be forwarded and shared until said expiration time is reached; and
said composite message is deleted once said expiration time is reached.

4. The apparatus of claim 1, wherein:
said composite message further comprises a limit resharing flag;
said messaging application disallows sharing by anyone other than said first user when said limit resharing flag is set.

5. The apparatus of claim 1, wherein:
said messaging application allows said first user to select or de-select a one or more of said messages from said first conversation so as to omit portions of said conversation; and
said messaging application combines said selected portions of said first conversation into said composite message.

6. The apparatus of claim 1, wherein:
said messaging application allows users to limit resharing of messages as between users outside of said first conversation.

7. The apparatus of claim 1, wherein:
said messaging application comprises a social network software allowing said plurality of users to connect and share information with one another; and
said messaging application allows users to post said composite messages to a newsfeed within said social network software.

8. The apparatus of claim 7, wherein:
said first user selectively posts said composite message is posted to a news feed;
said messaging application comprises a one or more newsfeed posts having at least a first newsfeed post;
said composite message is included with said first newsfeed post;
said one or more newsfeed posts each comprise one or more among a like count, a comment count, and a discussion zone; and
a portion of said plurality of users have access to said first newsfeed post.

9. The apparatus of claim 1, wherein:
said one or more messages comprise messages selected from among text, images, animated images, emoji, audio files, 3D images, or binary files.

10. The apparatus of claim 1, wherein:
said one or more messages, a user profile information, said composite messages, and historical transactions are stored on said server.

11. The apparatus of claim 1, wherein:
said composite message includes a hidden message comprising a placeholder within a composite message box;
said hidden message comprises a portion of said composite message which said first user wished to omit but to include a placeholder; and
said composite message box is displayed on a computer belonging to said second user with said contents of said composite message.

12. A method for creating and sharing a composite message, the method comprising:
installing and running a messaging application on a plurality of computers,
connecting said plurality of computers to one another and a server over a network,
executing said messaging application in a memory of said plurality of computers and said server,
facilitating a plurality of conversations between a plurality of users through said messaging application,
creating said composite message from selection of two or more messages within a first conversation,
providing a dialog for sending said composite message to a one or more among said plurality of users; and wherein,
each of the plurality of conversations comprising a one or more messages between a two or more among the plurality of users,
the plurality of users comprises at least a first user and a second user, and
the plurality of conversations comprises at least the first conversation between the first user and the second user.

13. The method of claim 12, wherein:
including an introduction message with said composite message; wherein,
the introduction message is written by the first user and included with the composite message. the messaging application includes the introduction message with the composite message.

14. The method of claim 12, wherein:
including an expiration time with said composite message; and wherein,
the messaging application allows the composite message to be forwarded and shared until the expiration time is reached, and
the composite message is deleted once the expiration time is reached.

15. The method of claim 12, wherein:
including a limit resharing flat with said composite message; and
disallowing sharing of said messaging application by anyone other than said first user when said limit resharing flag is set.

16. The method of claim 12, wherein:
allowing said first user to select or de-select a one or more of said messages from said first conversation so as to omit portions of said conversation; and
combining said selected portions of said first conversation into said composite message.

17. The method of claim 12, wherein:
allowing users of said messaging application to limit resharing of messages as between users outside of said first conversation.

18. The method of claim 12, wherein:
allowing said plurality of users to connect and share information with one another with a social network software within said messaging application; and
allowing users to post said composite messages to a newsfeed within said social network software.
